(19) United States
(12) Patent Application Publication
(10) Pub. No.: US 2008/0222556 A1
(43) Pub. Date: Sep. 11, 2008

(54) Layer menus and multiple page displays for web GUI

(75) Inventor: Russell F. McKnight, Sioux City, IA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway

(21) Appl. No.: 12/152,548

(22) Filed: May 15, 2008

Related U.S. Application Data
(62) Division of application No. 10/109,305, filed on Mar. 28, 2002.

(51) Int. Cl. G06F 3/048

(52) U.S. Cl. 715/781

(57) ABSTRACT

A method and apparatus for controlling the display of a main web page image or several major web page images as well as the optional display of a layer menu facilitates web browsing. The layer menu tracks the latest web pages which have been accessed by the user. Tracking may also be performed by a user selectable means including topic word. Buttons may be provided on the tool bar to choose between the display of a single main web page or the display of several web pages simultaneously. The layer menu may include thumbnails as well as the URL.

### FIELD OF THE INVENTION

This invention generally relates to the field of graphical user interfaces for information handling systems, and specifically, to a method and apparatus implementing a graphical user interface which has layered menus presented in a helpful, user friendly manner which enhances web browsing capability.

### BACKGROUND OF THE INVENTION

With faster processors, more memory and broadband Internet connections, it is possible to hold many more web pages open at the same time. For many web activities, including comparison shopping and research activities, it would be an advantage to be able to quickly jump back and forth between several web pages.

There are current methods which allow the user to view several windows or layers simultaneously on the computer monitor screen. Graphics programs such as Adobe Photoshop allow the user to put information on different layers. There are features in word-processing programs such as Microsoft Word that allow the user to view multiple documents at the same time.

Current methods of multiple window viewing known to the art fail to adequately increase the usability and speed of web browsing. The traditional back and forward buttons and the use of the history menu work, but these methods quickly become a burden since, for example, many clicks are required to navigate through multiple windows.

Therefore, it would be desirable to provide a means to view multiple pages on a single screen and to provide a user with a capability to expand a reference page from a thumbnail and/or URL to a window which occupies a significant portion of the monitor screen and is easily readable to the user.

### SUMMARY OF THE INVENTION

The present invention provides a method and an apparatus for keeping track of many pages and allows the user to quickly move back and forth between several web pages. Furthermore, it provides a method to view several web pages simultaneously.

In a first aspect of the present invention, a method of accessing two or more web pages of information through network communications is disclosed which includes the steps of paging through two or more web pages, at least one of the two or more web pages being displayed on a first portion of a monitor screen and displaying a layer menu on which there is information which identifies the individual ones of the two or more web pages which have been paged or selected, the layer menu being displayed on a second portion of the monitor screen. The second portion either is in a nonoverlapping relationship with the first portion or is disposed at a margin of the first portion.

In a second aspect of the present invention, an apparatus is disclosed for allowing a user to browse the web in a flexible and versatile manner which includes a processor coupled to a network; a monitor, coupled to the processor and having a screen; and an input means for data entry coupled to the processor, wherein the screen may display both a web page and a layer menu which lists one or more web pages.

In a third aspect of the present invention, a computer program of machine readable instructions is disclosed which includes code to perform the following steps: paging through two or more web pages, at least one of the two or more web pages being displayed on a first portion of a monitor screen; and displaying a layer menu on which there is information which identifies the individual ones of the two or more web pages which have been paged or selected, the layer menu being displayed on a second portion of the monitor screen. The second portion either is in a nonoverlapping relationship with the first portion or is disposed at a margin of the first portion.

The present invention describes a graphical user interface (GUI) with a human factors design which allows the user to more quickly access pages previously viewed and to view several pages simultaneously.

The present invention uses a layer menu that records the web address and a thumbnail graphic of each page visited or each page which fits a preselected criterion.

The present invention in one embodiment adds two buttons to the button bar that allow the viewer to switch between a single page view and a multiple page view.

The present invention provides the ability to select several pages from the layer menu and then drag them to the screen to view all the pages simultaneously.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates an embodiment of the present invention with a single web page displayed in large form;

FIG. 2 illustrates an embodiment in which buttons allow switching between a single web page format and a multi web page format;

FIG. 3 illustrates an embodiment of the present invention with a multi web page format;

FIG. 4 illustrates a functional flow chart of the method of the present invention;

FIG. 5 an embodiment of the present invention using the view menu to allow for changing the display of the layer menu and the display of multiple web pages;

FIG. 6 illustrates an embodiment with submenus which allow for multiple array settings and border control; and

FIG. 7 illustrates an embodiment of a layer menu.

### DETAILED DESCRIPTION OF THE INVENTION

Reference will now be made in detail to the presently preferred embodiments of the invention, examples of which are illustrated in the accompanying drawings.

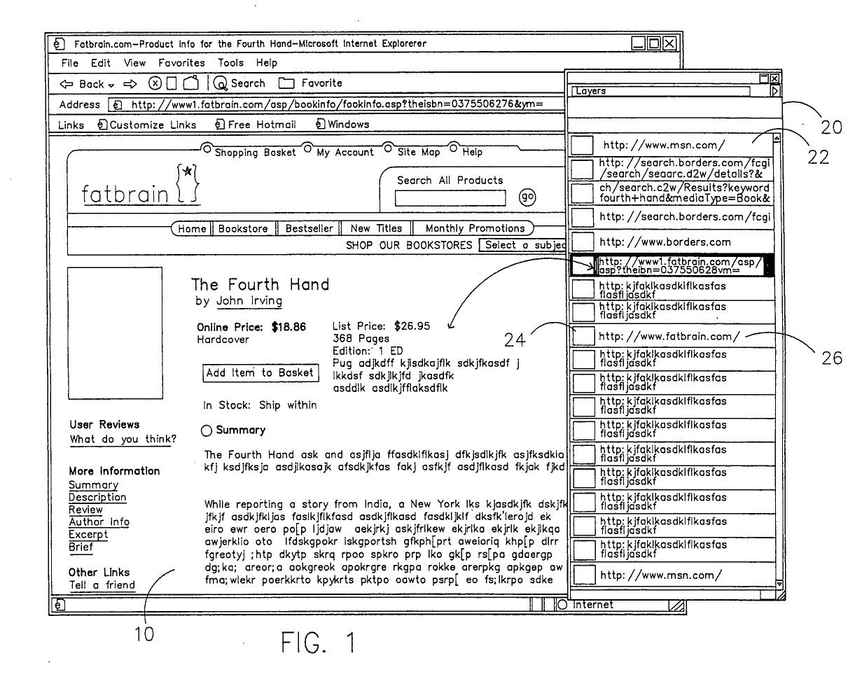

Referring generally now to FIGS. 1 through 7, exemplary embodiments of the present invention are shown.

The present invention uses an apparatus which includes a computer monitor and a processor in an information handling system. The processor is coupled to a network, such as the Internet. Any web access process may recognize such parameters as the universal resource locator (URL). Web access processing known in the art may be used in conjunction with the present invention. The processor should be capable of displaying, formatting, scaling, and other functions associated with the display of windows.

In the present invention, an Internet or web graphical user interface (GUI) allows users to access previously viewed pages more quickly and to view several web pages simultaneously. This invention involves using a layer menu that records the web address which optionally includes a thumbnail graphic of each page visited. It also may include adding two buttons to the tool bar that allows the user to switch between a single page view and a multiple page view. Finally, the method had the ability to select several pages from the layer menu and to drag the pages to the screen in order to view all of the web pages simultaneously.

The present invention relates to a method that allows the web user to view a layer menu on a screen which records each web address visited and shows a small thumbnail of each page. The user can click on any layer to instantly access that page. The layer menu is to be displayed as a window and contain a list of URLs, thumbnails, or a URL with thumbnail. Layout of the layer menu window is important for human factors considerations. In an embodiment, the layer menu occupies approximately ⅕ of the monitor screen and each URL with corresponding thumbnail occupies approximately ⅙ the width of the computer monitor screen and approximately 1/20 the height of the screen. These dimensions may be varied to provide versatility and utility.

FIG. 1 shows an implementation of the layer menu with a single page displayed. In this example, the user is shopping for John Irving's new book, the Fourth Hand. To find the best price, he visits four web sites (amazon.com, barnesnoble.com, fatbrain.com, and borders.com). At each site, it takes four clicks to get to the page describing the book. After finding the four pages that price the book, the user can reference the layer menu to toggle back and forth between the four sites to compare pricing, shipping, availability, and reviews on the various sites. Or, the user can click a button on the web interface to view multiple pages simultaneously. When the multiple page button is selected, the user can shift-click several pages on the layer menu and drag them to the web interface to simultaneously view several pages. In the example shown, the user is looking at four websites to compare price, shipping options and available reviews for John Irving's book, the Fourth Hand. This method of combining a layer menu with multiple page viewing allows the user to more effectively carry out comparisons between web sites. In one embodiment, the displayed web page corresponds to a highlighted entry in the layer menu window.

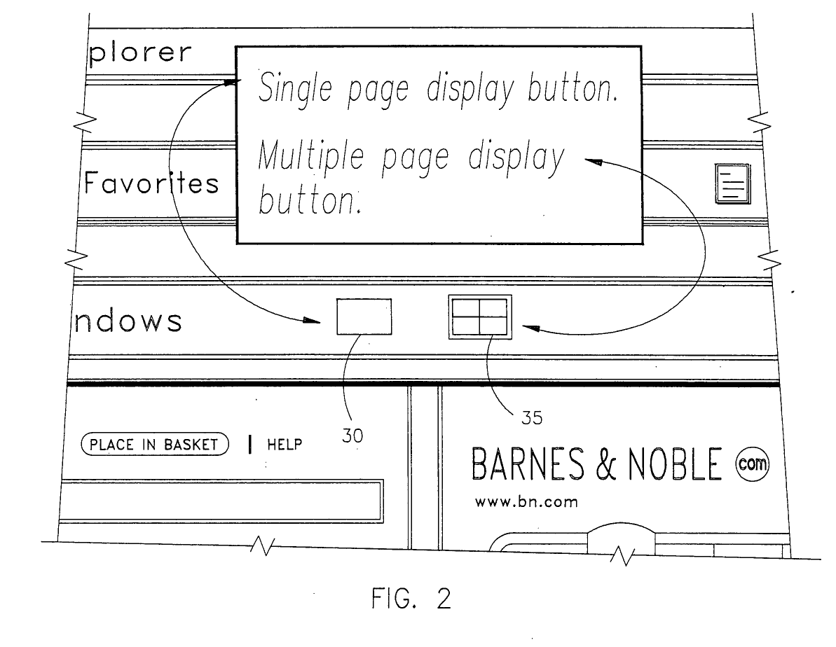

FIG. 2 shows tool bar buttons for displaying pages. Icons or similar graphical objects may be used as alternatives or in addition to the tool bar buttons. Yet, alternatively, a keyboard button may be used to implement this process. The tool bar buttons provide the user with the ability to see a single page which occupies a large portion of the computer monitor screen or four pages, each in a different quadrant, in a large portion of the computer monitor screen. In another embodiment, yet another button is provided which presents nine pages in a large portion of the computer monitor screen. The large portion of the computer monitor screen may occupy the entire computer monitor screen except for the portion which is occupied by the layer menu window. In certain applications, sixteen pages or a higher number of pages may be displayed in the large portion of the computer monitor screen. Options may be provided for selecting certain arrangements in which the pages may be displayed. For example, the pages may be displayed in a three by four format. The software running the windows type application may automatically arrange the large screen view area to accommodate various numbers of selected or displayed images by an algorithm made part of the computer code. For example, five highlighted selections may result in three pages displayed in an upper row and two pages in the lower row. If there are more than a few options, it may be preferable to select them via a menu such as the “view” menu.

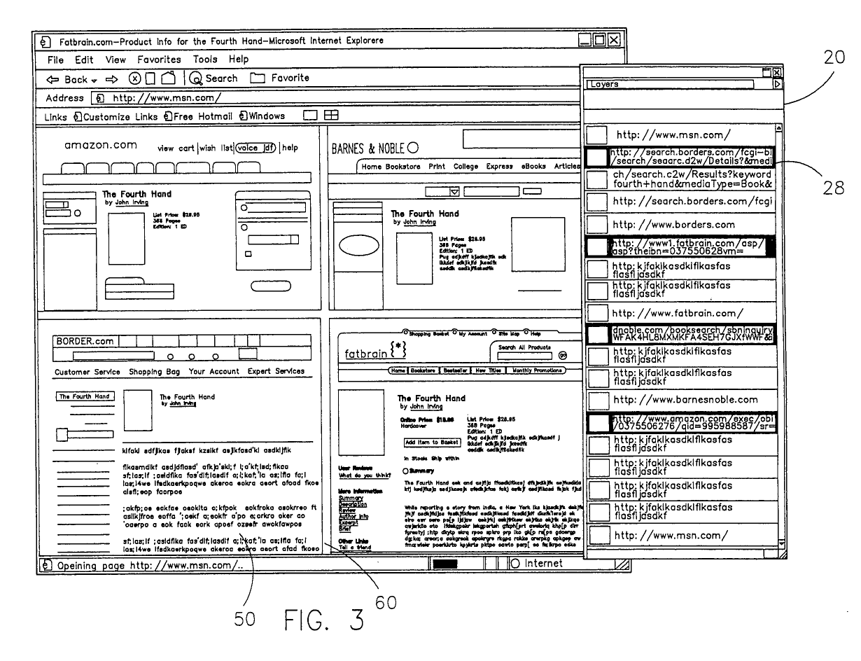

FIG. 3 shows a four page display format. For enhanced visibility, a border framing the individual pages may be used as shown. This border may also be an optional feature so that more information is displayed in a multipage format. Such an option may be presented to the user through a “view” menu or other menu. The border may be turned off or on in the menu. The thickness of the border may be made selectable through user input data via a selection menu for the border that would allow the user to enter a thickness parameter from a limited number of selections or by a numerical entry. Attributes of the border may be selected as well; for example, color, shading, animation, etc. Also, the border may be highlighted around a particular one of the pages in a multipage format. This may be accomplished by simply clicking on the desired page.

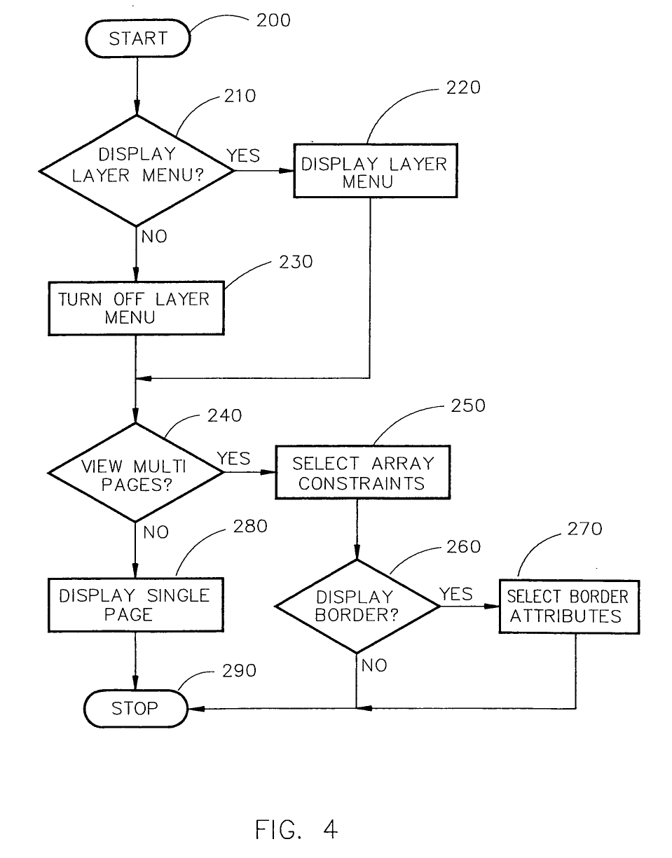

FIG. 4 illustrates a functional flow chart of the method of the present invention. The start 200 and stop 210 steps may be repeated with some periodicity by the processor. The periodicity may be set at such a rate that a user can have the feeling of instantaneous response to his command. The periodicity of polling may be set, for this purpose, to once or twice per second. In step 210, a determination is made as to whether the layer menu is to be displayed. If it is, then the layer menu is displayed, as per step 220. Otherwise, the layer menu is turned off, step 230, removing the layer menu from the monitor screen. A determination is made as to whether multiple pages are to be displayed, step 240. If they are not to be displayed, then the monitor screen displays only a single web page in its allotted area, step 280. Otherwise, array constraints are selected, step 250. These constraints may be selected by placing the cursor over a given size and pressing a mouse button or other entry mechanism. An option may be provided to allow the user to manually enter the array size. Optionally, the user may choose not to display a border, step 260. If the user chooses to display a border, the user may choose attributes regarding the border, step 270. The choices may include width of the border, shading of the border, color, animation features, etc.

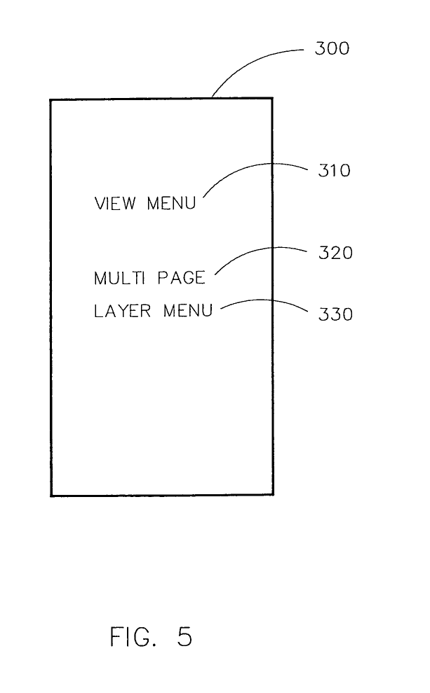

FIG. 5 illustrates an embodiment in which a pull down menu 300 includes options for multipage simultaneous viewing 320 and a layer menu 330. As shown here, the view menu is used to supply the options. These options may appear in a different pull down menu such as tools or may be incorporated in their own separate pull down menu. Nested menus may be used. Alternatively, buttons may be provided in the top of the window to allow for certain features, such as the embodiment of FIG. 2.

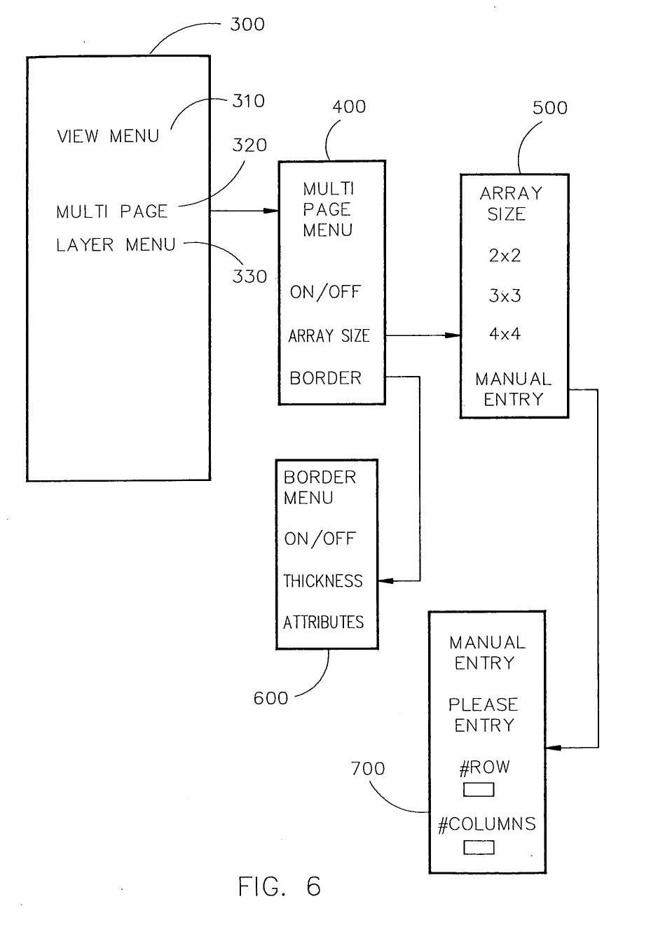

FIG. 6 illustrates multiple levels of menus to change the view attributes in the present invention. The selection of the multipage option 320 may result in a multipage menu 400 which allows the user to toggle off or on multipage mode, set the array size of the pages to be displayed simultaneously, and change the border between pages simultaneously displayed. An example of the array size option displays an array size menu 500. Certain options such as fixed array sizes may be selected by moving the cursor on the screen to the option and clicking. In this example, the user may also choose to manually enter the size of the array to be displayed. The manual entry menu 700 permits entry of a number of rows and columns. The user may choose from the multipage menu of the example to change attributes of the border which appears between web pages simultaneously shown. A border menu 600 may have an off/on toggle selection. Options may be provided for changing the thickness, color, and shading. It may be desirable to some users to animate the border in some fashion. Other variations and combinations are contemplated by this invention.

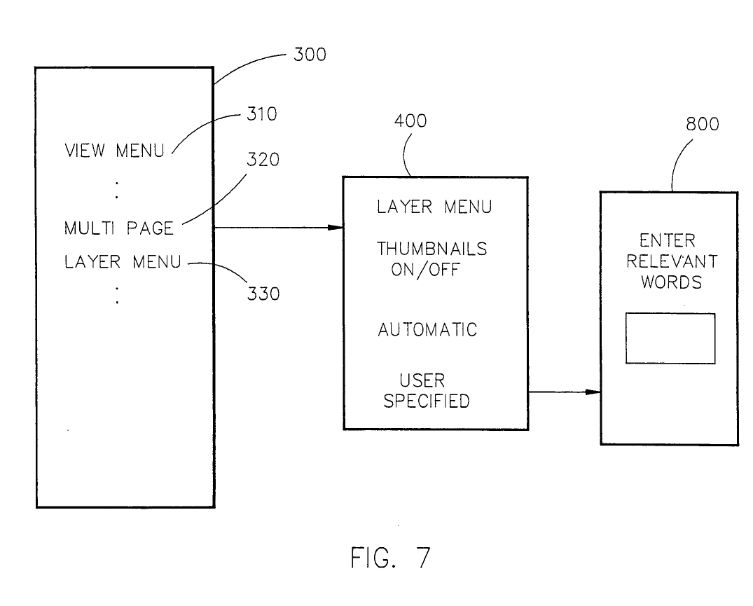

FIG. 7 illustrates an embodiment of the layer menu option 330. Selecting this option may provide a layer menu 400. This layer menu may have certain features including, but not limited to, toggling the thumbnails off or on, making page selection for the layer menu through the default processes built into the code (automatically), or through some user specified means. The user specified means may be through a submenu 800 which permits the user to establish the criteria for choosing a page to be displayed in the layer menu. This could be through one or more keywords.

Other options may be used. The layer menu window may have shrink button to allow the window to fall back onto a button or tool bar. A maximum number of entries in the layer menu may be set. This may be 10, 16, 32, or some other number. The layer menu may be implemented so that it only appears after a certain number of pages are accessed or selected. This may be two or a higher number. A drop and drag feature may be implemented so that the user may depress a selection from the layer menu and place the corresponding web page on the screen. Placement may result in an increase in the number of web pages displayed or may result in replacing the older web page beneath the drop point.

The user may interact with the graphical user interface by various means. The interaction may be through a touch screen, a mouse, a track ball, etc.

The present invention may be implemented as part of the computer instructions of the software program in a windows type application, as a separate application capable of interpreting a web related language such as hyper text markup language (HTML), as a plug in, or by other means.

It is believed that the method, apparatus, and computer program for layer menus and multiple page displays for web GUI of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1.-33. (canceled)

34. A method of managing a display of web pages and web page sites, comprising:
recording a plurality of web addresses visited by a user;
presenting a layer menu window containing a list of layer menu items, each layer menu item displaying individual ones of the plurality of web addresses visited, the layer menu window being presented on a first portion of a display screen; and
presenting in a window on a second portion of the display screen a web page corresponding to a layer menu item selected by the user in response to selection of that layer menu item by the user.

35. The method of claim 34, wherein the first portion is in a nonoverlapping relationship with the second portion.

36. The method of claim 34, wherein the first portion is disposed at a margin of the second portion.

37. The method of claim 34, wherein the layer menu items contain the most recently visited ones of the web addresses.

38. The method of claim 34, wherein multiple web pages are presented simultaneously in the window on the second portion of the display screen, and wherein a characteristic about a format for presenting the web pages simultaneously on the first portion of the display screen is adjustable.

39. The method of claim 38, wherein a quantity reflecting a number of the web pages to be presented simultaneously is set by pressing a button on a tool bar.

40. The method of claim 38, wherein a size of an array for the web pages to be presented in the second portion of the display screen is determined by numerical information received through instructions to a processor.

41. The method of claim 38, wherein one of at least two selections of an array size for the web pages presented in the second portion of the display screen is selected through instructions received by a processor.

42. The method of claim 38, wherein a quantity of web pages presented is automatically determined by a processor which controls the display screen.

43. The method of claim 38, wherein said multiple web pages presented are selected by the user by dragging individual ones of the layer menu items to the window on the second portion of the display screen.

44. The method of claim 34, wherein the layer menu window is not presented until at least two web pages have been visited by the user.

45. The method of claim 34, further comprising recording a thumbnail graphic of the web page at each of the plurality of web. addresses visited, wherein each layer menu item further displays the thumbnail graphic corresponding to the web address displayed by the layer menu item.

46. An apparatus for allowing a user to browse the web in a flexible and versatile manner, comprising:
a processor coupled to a network;
a memory coupled to the processor;
a display device, coupled to the processor and having a display screen;
an input means for data entry coupled to the processor; and
a program of instructions which causes the processor to record in the memory a plurality of web addresses visited by a user, and present on the display screen both a layer menu which lists at least two web of the web addresses visited and at least one web page corresponding to at least one of the web address selected by the user from the layer menu using the input means, the at least one web page being presented in a first portion of the display screen and the layer menu being presented on a second portion of the display screen, wherein a button on a tool bar allows a user to control the presentation of the at least one web page.

47. The apparatus of claim 46, wherein the second portion is in a nonoverlapping relationship with the first portion.

48. The apparatus of claim 46, wherein the second portion is disposed at a margin of the first portion.

49. The apparatus of claim 46, wherein the layer menu contains most recently visited ones of the web addresses.

50. The apparatus of claim 46, wherein the program of instructions causes the processor to present at least two web pages simultaneously on the first portion of the display screen, wherein a characteristic about a format for presenting the at least two web pages simultaneously on the first portion of the display screen is adjustable.

51. The apparatus of claim 50, wherein a quantity reflecting a number of the web pages to be presented simultaneously is set by pressing the button on the tool bar.

52. The apparatus of claim 50, wherein a size of an array of the web pages to be presented in the first portion of the display screen is determined by numerical information received through instructions to the processor.

53. The apparatus of claim 50, wherein one of at least two selections of an array size for the web pages presented in the first portion of the display screen is selected through instructions received by the processor.

54. The apparatus of claim 50, wherein a quantity of the web pages presented is automatically determined by the processor which controls the display screen.

55. The apparatus of claim 46, wherein the layer menu is not presented until at least two web pages have been presented to the user.

56. The apparatus of claim 46, wherein said program of instructions further causes the processor to record in the memory a thumbnail graphic of the web page at each of the plurality of web sites visited by a user, and present the thumbnail graphic corresponding to each web page address listed in the layer menu.

57. The apparatus of claim 46, wherein the at least one web page presented in the first portion of the display screen is selected by the user dragging the corresponding web page address from the layer menu to the first portion of the display screen.
